(19) United States
(12) Patent Application Publication
(10) Pub. No.: US 2017/0276561 A1
(43) Pub. Date: Sep. 28, 2017

(54) PRESSURE SENSOR, ALTIMETER, ELECTRONIC APPARATUS, AND VEHICLE

(71) Applicant: SEIKO EPSON CORPORATION, Tokyo (JP)

(72) Inventor: Hiroyuki SHIMADA, Chuo-shi (JP)

(73) Assignee: SEIKO EPSON CORPORATION, Tokyo (JP)

(21) Appl. No.: 15/458,282

(22) Filed: Mar. 14, 2017

(30) Foreign Application Priority Data
Mar. 28, 2016 (JP) 2016-063262

(51) Int. Cl. G01L 7/08; G01C 5/06

(52) U.S. Cl. CPC G01L 7/082; G01C 5/06

(57) ABSTRACT

A pressure sensor includes a diaphragm that flexurally deforms when pressurized, a plurality of piezoresistive elements provided in the diaphragm, and a plurality of temperature-sensitive elements provided in the diaphragm in correspondence with the plurality of piezoresistive elements, wherein a separation distance between the piezoresistive element and the temperature-sensitive element corresponding to each other is shorter than a separation distance between the piezoresistive element and the temperature-sensitive element not corresponding to each other. Further, each of the temperature-sensitive elements is provided to at least partially overlap with the corresponding piezoresistive element in a plan view of the diaphragm.

### BACKGROUND

1. Technical Field

The present invention relates to a pressure sensor, altimeter, electronic apparatus, and vehicle.

2. Related Art

In related art, as a pressure sensor, a configuration having a diaphragm that flexurally deforms when pressurized and a piezoresistive element provided in the diaphragm, and detecting a magnitude of the pressure on the diaphragm from a change in resistance value of the piezoresistive element based on the flexural deformation of the diaphragm is known (for example, see Patent Document 1 (JP-A-6-213744)).

In the pressure sensor of Patent Document 1, a temperature compensation sensor is further provided near the piezoresistive element outside of the diaphragm for temperature compensation of the piezoresistive element (correction of changes in resistance value of the piezoresistive element with changes in environment temperature). Thereby, temperature drift (output changes depending on the temperature) is reduced.

However, in Patent Document 1, since the temperature compensation sensor is located outside of the diaphragm, the distance between the temperature compensation sensor and the piezoresistive element is larger and it may be impossible to sense the precise temperature of the piezoresistive element. Further, it may be impossible to individually sense the temperatures of the respective piezoresistive elements. Accordingly, in the pressure sensor of Patent Document 1, it may be impossible to correct output drift due to temperature variations of the respective piezoresistive elements in real time or sense pressure with high accuracy.

### SUMMARY

An advantage of some aspects of the invention is to provide a pressure sensor having a superior detection accuracy, altimeter, electronic apparatus, and vehicle including the pressure sensor with higher reliability.

The advantage of the invention can be realized by the following configurations.

A pressure sensor according to an aspect of the invention includes a diaphragm that flexurally deforms when pressurized, a plurality of piezoresistive elements provided in the diaphragm, and a plurality of temperature-sensitive elements provided in the diaphragm in correspondence with the plurality of piezoresistive elements, wherein a separation distance between the piezoresistive element and the temperature-sensitive element corresponding to each other is shorter than a separation distance between the piezoresistive element and the temperature-sensitive element not corresponding to each other.

With this configuration, changes in resistance value of the piezoresistive elements may be corrected based on sensing results of the temperature-sensitive elements, and the pressure sensor harder to be affected by the environment temperature and having superior detection accuracy is obtained.

In the pressure sensor according to the aspect of the invention, it is preferable that each of the temperature-sensitive elements is provided to at least partially overlap with the corresponding piezoresistive element in a plan view of the diaphragm.

With this configuration, the temperature-sensitive elements may be provided closer to the corresponding piezoresistive elements. Accordingly, the temperatures of the piezoresistive elements may be sensed more precisely.

In the pressure sensor according to the aspect of the invention, it is preferable that an insulating film is provided between the piezoresistive element and the temperature-sensitive element provided to overlap with the piezoresistive element.

With this configuration, the possibility of short circuit between the piezoresistive elements and the temperature-sensitive elements may be reduced.

In the pressure sensor according to the aspect of the invention, it is preferable that each of the temperature-sensitive elements is provided side by side with the corresponding piezoresistive element.

With this configuration, the temperature-sensitive elements may be provided closer to the corresponding piezoresistive elements. Accordingly, the temperatures of the piezoresistive elements may be sensed more precisely.

In the pressure sensor according to the aspect of the invention, it is preferable that a pair of the temperature-sensitive elements are provided with the corresponding piezoresistive element in between.

With this configuration, for example, average values of the temperatures detected by the pairs of temperature-sensitive elements are employed, and the temperatures of the piezoresistive elements may be sensed more precisely.

In the pressure sensor according to the aspect of the invention, it is preferable that separation distances between the respective temperature-sensitive elements and an outer edge of the diaphragm are respectively equal.

With this configuration, stress on the respective temperature-sensitive elements due to flexure of the diaphragm may be made equal.

In the pressure sensor according to the aspect of the invention, it is preferable that each of the temperature-sensitive elements has a temperature-sensitive portion including an oxide semiconductor having an electric resistance that varies depending on the temperature.

With this configuration, the configuration of the temperature-sensitive elements may be simpler.

In the pressure sensor according to the aspect of the invention, it is preferable that each of the temperature-sensitive elements has a temperature-sensitive portion including impurity-containing polysilicon having an electric resistance that varies depending on the temperature.

With this configuration, the configuration of the temperature-sensitive elements may be simpler.

In the pressure sensor according to the aspect of the invention, it is preferable that a bridge circuit is formed by the plurality of piezoresistive elements.

The pressure may be accurately detected based on the output from the bridge circuit.

In the pressure sensor according to the aspect of the invention, it is preferable that the bridge circuit has a correction part that corrects resistance values of the corresponding piezoresistive elements based on sensing results of the temperature-sensitive elements.

With this configuration, the pressure may be detected more accurately.

An altimeter according to an aspect of the invention includes the pressure sensor according to the aspect of the invention.

With this configuration, the altimeter with higher reliability is obtained.

An electronic apparatus according to an aspect of the invention includes the pressure sensor according to the aspect of the invention.

With this configuration, the electronic apparatus with higher reliability is obtained.

A vehicle according to an aspect of the invention includes the pressure sensor according to the aspect of the invention.

With this configuration, the vehicle with higher reliability is obtained.

### BRIEF DESCRIPTION OF THE DRAWINGS

The invention will be described with reference to the accompanying drawings, wherein like numbers reference like elements.

FIG. 1 is a sectional view of a pressure sensor according to a first embodiment of the invention.

FIG. 2 is an enlarged sectional view of a diaphragm of the pressure sensor shown in FIG. 1.

FIG. 3 is a plan view showing a pressure sensor part of the pressure sensor shown in FIG. 1.

FIG. 4 shows abridge circuit containing the pressure sensor part shown in FIG. 3.

FIG. 5 is a plan view showing a temperature sensor part of the pressure sensor shown in FIG. 1.

FIG. 6 is a plan view of a pressure sensor according to a second embodiment of the invention.

FIG. 7 is a plan view showing a modified example of the pressure sensor shown in FIG. 6.

FIG. 8 is a sectional view of a pressure sensor according to a third embodiment of the invention.

FIG. 9 is a perspective view showing an example of an altimeter according to the invention.

FIG. 10 is a front view showing an example of an electronic apparatus according to the invention.

FIG. 11 is a perspective view showing an example of a vehicle according to the invention.

### DESCRIPTION OF EXEMPLARY EMBODIMENTS

As below, a pressure sensor, an altimeter, an electronic apparatus, and a vehicle according to the invention will be explained in detail based on embodiments shown in the accompanying drawings.

### First Embodiment

First, a pressure sensor according to the first embodiment of the invention will be explained.

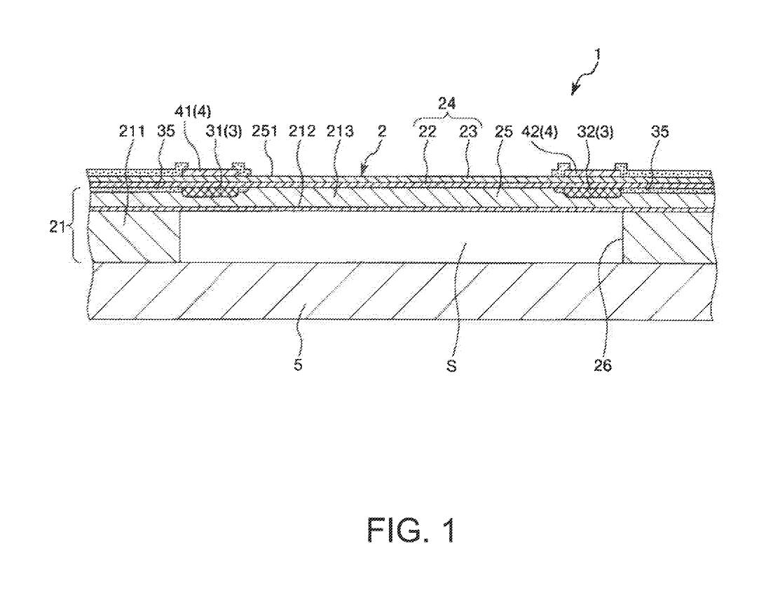

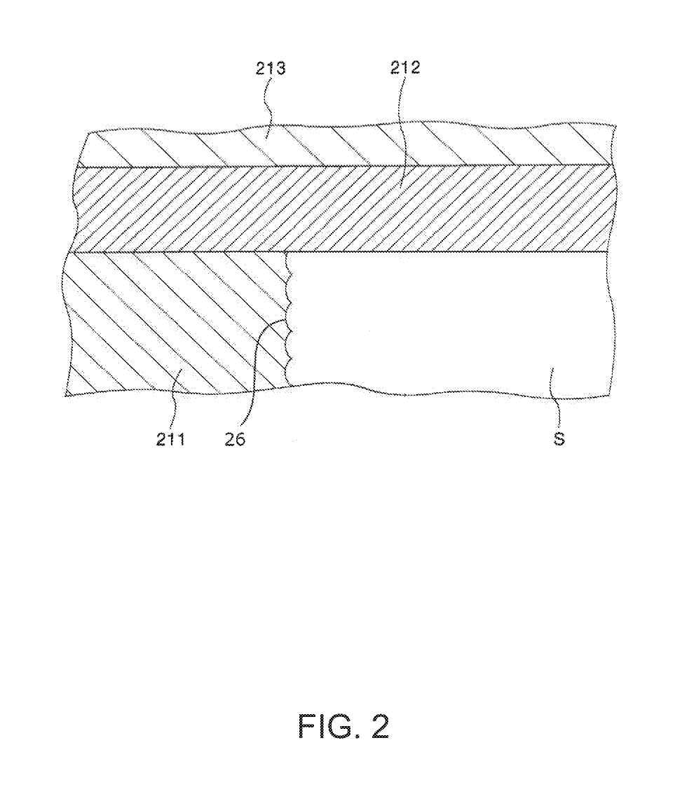

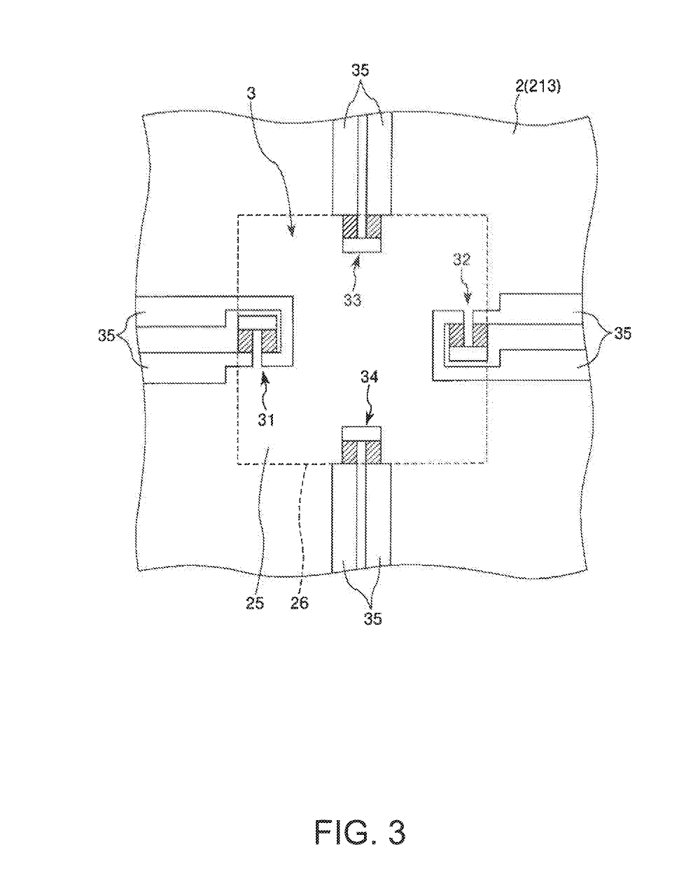

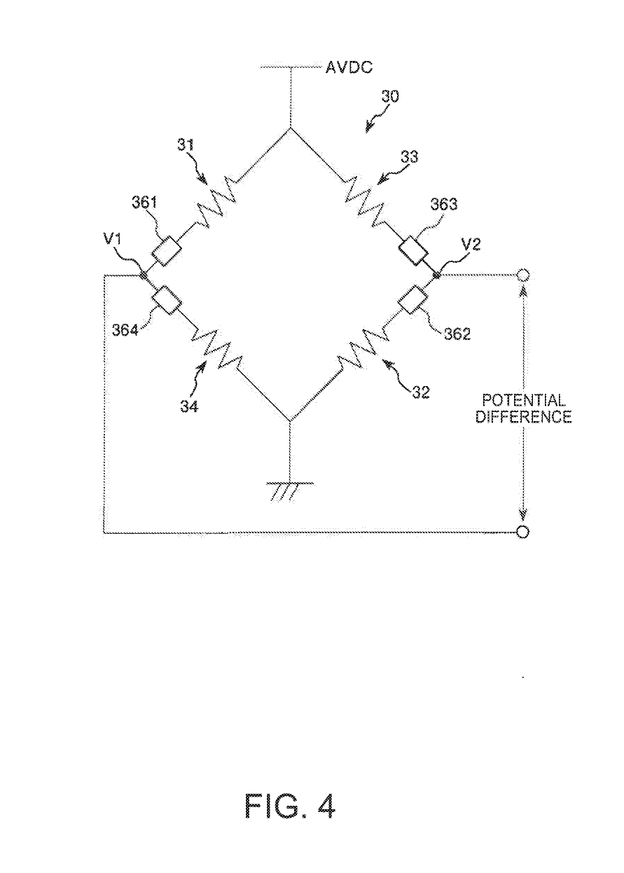

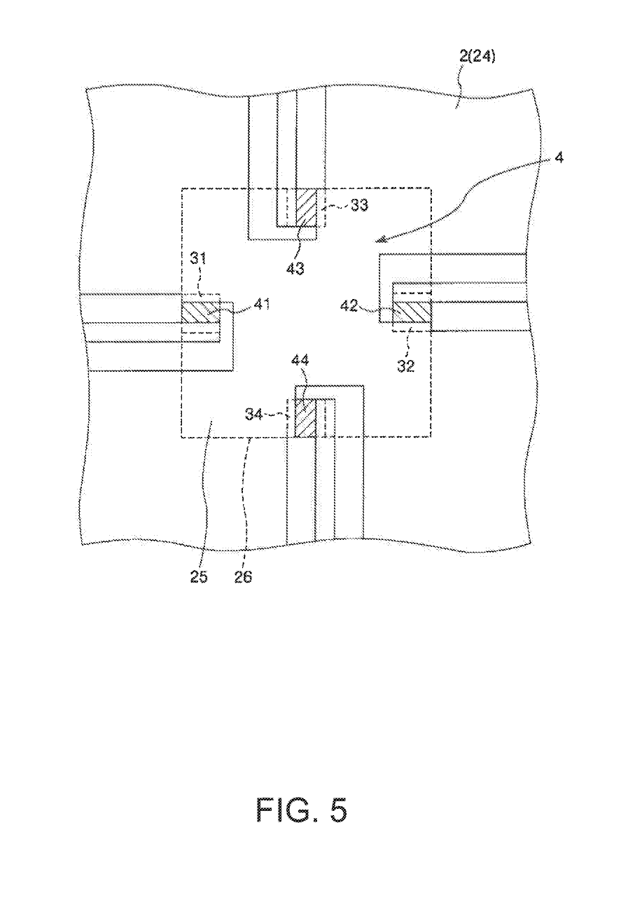

FIG. 1 is a sectional view of the pressure sensor according to the first embodiment of the invention. FIG. 2 is an enlarged sectional view of a diaphragm of the pressure sensor shown in FIG. 1. FIG. 3 is a plan view showing a pressure sensor part of the pressure sensor shown in FIG. 1. FIG. 4 shows a bridge circuit containing the pressure sensor part shown in FIG. 3. FIG. 5 is a plan view showing a temperature sensor part of the pressure sensor shown in FIG. 1. Note that, in the following explanation, the upside in FIG. 1 is also referred to “upper” and the downside is also referred to as “lower”. Further, a plan view of a substrate 2 (a plan view as seen from the upside in FIG. 1) is also simply referred to as “plan view”.

As shown in FIG. 1, a pressure sensor has a diaphragm 25 that flexurally deforms when pressurized, a plurality of piezoresistive elements 31, 32, 33, 34 provided in the diaphragm 25 (see FIG. 3), and a plurality of temperature-sensitive elements 41, 42, 43, 44 provided in the diaphragm 25 in correspondence with the plurality of piezoresistive elements 31, 32, 33, 34 (see FIG. 5). The separation distance between the piezoresistive element and the temperature-sensitive element corresponding to each other is shorter than the separation distance between the piezoresistive element and the temperature-sensitive element not corresponding to each other. According to the configuration, changes in resistance value of the piezoresistive elements 31, 32, 33, 34 depending on the environment temperature may be corrected based on sensing results of the temperature-sensitive elements 41, 42, 43, 44, and thereby, the pressure sensor 1 harder to be affected by the environment temperature and having superior detection accuracy is obtained. In other words, temperature characteristics of the individual piezoresistive elements are corrected using detection data of the individual temperature-sensitive elements, and thereby, the more superior pressure sensor 1 with higher detection accuracy is obtained. As below, the pressure sensor 1 will be explained in detail.

The pressure sensor 1 has the substrate 2, a pressure sensor part 3 and a temperature sensor part 4 provided on the substrate 2, a base substrate 5 bonded to the substrate 2, and a pressure reference chamber S (cavity part) formed between the substrate 2 and the base substrate 5.

### Substrate

As shown in FIG. 1, the substrate 2 has an SOI substrate 21 (i.e., a substrate having a first silicon layer 211, a silicon oxide layer 212, and a second silicon layer 213 stacked in this order), a first insulating film 22 provided on the upper surface of the SOI substrate 21 and formed by a silicon oxide film (SiO2 film), and a second insulating film 23 provided on the upper surface of the first insulating film 22 and formed by a silicon nitride film (SiN film). The first insulating film 22 stabilizes the interface states of the piezoresistive elements 31, 32, 33, 34 and the second insulating film 23 protects the pressure sensor part 3 from moisture and dust. Further, the first, second insulating film 22, 23 also have functions of insulating the pressure sensor part 3 and the temperature sensor part 4.

Note that, in place of the SOI substrate 21, e.g. a silicon substrate may be used. Further, the first insulating film 22 and the second insulating film 23 may be formed using different materials as long as they may exert the same effects. Or, in place of the first, second insulating film 22, 23, e.g. a single layer of silicon oxynitride (SiON) film may be used. Or, the first insulating film 22 and the second insulating film 23 may be provided or omitted as appropriate.

As shown in FIG. 1, the diaphragm 25 having a thinner thickness than the surrounding portions and flexurally deforming when pressurized is provided in the substrate 2. The SOI substrate 21 has a recessed portion 26 opening in the lower surface and having a bottom, and the diaphragm 25 is formed in the bottom part of the recessed portion 26. The upper surface of the diaphragm 25 serves as a pressure receiving surface 251. Note that, in the embodiment, the plan view shape of the diaphragm 25 is nearly square, however, the plan view shape of the diaphragm 25 includes, but is not particularly limited to, e.g. a circular shape.

In the embodiment, the recessed portion 26 is formed by dry etching using a silicon deep etching apparatus. Specifically, steps of isotropic etching, protective film deposition, and anisotropic etching from the lower surface side of the SOI substrate 21 are repeated, the first silicon layer 211 is dug, and thereby, the recessed portion 25 is formed. The steps are repeated and, when etching reaches the silicon oxide layer 212, the etching ends at the silicon oxide layer 212 as an etching stopper, and thereby, the recessed portion 26 is obtained. By the repetition of the above described steps, as shown in FIG. 2, periodical concavity and convexity are formed on the inner wall side surface of the recessed portion 26 in the digging direction.

The method of forming the diaphragm 25 is not limited to the above described method. For example, wet etching may be used for the formation. Further, the silicon oxide layer 212 may be removed from the lower surface of the diaphragm 25.

For example, in the case of the diaphragm 25 having a size with one side of 125 μm, the thickness (average thickness) of the diaphragm 25 is not particularly limited, but preferably from 1 μm to 10 μm, more preferably from 1 μm to 5 μm, and even more preferably from 1 μm to 3 μm. Within the ranges, the diaphragm 25 having sufficiently high sensitivity and high resistance to brittle fracture is obtained.

### Pressure Sensor Part

As shown in FIG. 3, the pressure sensor part 3 has the four piezoresistive elements 31, 32, 33, 34 provided in the diaphragm 25 (the shaded parts in the drawing are the piezoresistive portions). Further, the four (plurality of) piezoresistive elements 31, 32, 33, 34 are electrically connected to one another via wires 35 or the like and form a bridge circuit 30 (Wheatstone bridge circuit) shown in FIG. 4. A drive circuit (not shown) that supplies a drive voltage AVDC is connected to the bridge circuit 30. The bridge circuit 30 outputs a detection signal (voltage) according to the changes in resistance value of the piezoresistive elements 31, 32, 33, 34 based on the flexure of the diaphragm 25. Accordingly, the pressure on the diaphragm 25 may be detected based on the output detection signal. As described above, the pressure may be accurately detected based on the output from the bridge circuit 30.

Particularly, the piezoresistive elements 31, 32, 33, 34 are arranged along the outer edge of the diaphragm 25. As described above, when the diaphragm 25 flexurally deforms when pressurized, large stress is applied to the end portion of the diaphragm 25. The piezoresistive elements 31, 32, 33, 34 are provided in the end portion, and thereby, the above described detection signal may be increased and pressure detection sensitivity is improved. Note that the arrangement of the piezoresistive elements 31, 32, 33, 34 is not particularly limited, but the piezoresistive elements 31, 32, 33, 34 may be provided over the outer edge of the diaphragm 25, for example.

Each of the piezoresistive elements 31, 32, 33, 34 is formed by doping (diffusion or implantation) of an impurity such as phosphorus or boron in the second silicon layer 213 of the SOI substrate 21, for example. Further, the wires 35 are formed by doping (diffusion or implantation) of an impurity such as phosphorus or boron in the second si icon layer 213 of the SOI substrate 21 at a higher concentration than that of the piezoresistive elements 31, 32, 33, 34.

Note that the bridge circuit 30 may be formed within the pressure sensor 1 or formed by connection to an external device such as an IC.

### Temperature Sensor Part

As shown in FIG. 5, the temperature sensor part 4 has the four temperature-sensitive elements 41, 42, 43, 44 provided in correspondence with the piezoresistive elements 31, 32, 33, 34. The temperature-sensitive element 41 is provided in correspondence with and close to the piezoresistive element 31 and senses the temperature of the piezoresistive element 31. The temperature-sensitive element 42 is provided in correspondence with and close to the piezoresistive element 32 and senses the temperature of the piezoresistive element piezoresistive element 32. The temperature-sensitive element 43 is provided in correspondence with and close to the piezoresistive element 33 and senses the temperature of the piezoresistive element 33. The temperature-sensitive element 44 is provided in correspondence with and close to the piezoresistive element 34 and senses the temperature of the piezoresistive element 34.

The separation distance between the temperature-sensitive element 41 and the piezoresistive element 31 is shorter than the separation distances between the temperature-sensitive element 41 and the piezoresistive elements 32, 33, 34 (i.e., the piezoresistive elements not corresponding thereto), the separation distance between the temperature-sensitive element 42 and the piezoresistive element 32 is shorter than the separation distances between the temperature-sensitive element 42 and the piezoresistive elements 31, 33, 34, the separation distance between the temperature-sensitive element 43 and the piezoresistive element 33 is shorter than the separation distances between the temperature-sensitive element 43 and the piezoresistive elements 31, 32, 34, and the separation distance between the temperature-sensitive element 44 and the piezoresistive element 34 is shorter than the separation distances between the temperature-sensitive element 44 and the piezoresistive elements 31, 32, 33. According to the configuration, the temperatures of the piezoresistive elements 31, 32, 33, 34 may be individually and accurately sensed by the temperature-sensitive elements 41, 42, 43, 44. Accordingly, as described above, the changes in resistance value of the piezoresistive elements 31, 32, 33, 34 depending on the environment temperature may be corrected (compensated) with higher accuracy, and the pressure sensor 1 harder to be affected by the environment temperature and having the superior detection accuracy is obtained.

The arrangement of the temperature-sensitive elements 41, 42, 43, 44 is explained in further details. As shown in FIG. 5, in the plan view of the diaphragm 25, the temperature-sensitive element 41 is provided to at least partially overlap with the piezoresistive element 31, the temperature-sensitive element 42 is provided to at least partially overlap with the piezoresistive element 32, the temperature-sensitive element 43 is provided to at least partially overlap with the piezoresistive element 33, and the temperature-sensitive element 44 is provided to at least partially overlap with the piezoresistive element 34. In other words, the temperature-sensitive element 41 is provided to face the piezoresistive element 31, the temperature-sensitive element 42 is provided to face the piezoresistive element 32, the temperature-sensitive element 43 is provided to face the piezoresistive element 33, and the temperature-sensitive element 44 is provided to face the piezoresistive element 34. That is, the respective piezoresistive elements and the corresponding temperature-sensitive elements are opposed via the first insulating film 22 and the second insulating film 23, for example. As described above, the temperature-sensitive elements 41, 42, 43, 44 are provided to overlap with (to face) the corresponding piezoresistive elements 31, 32, 33, 34, and thereby, the separation distances between the temperature-sensitive elements 41, 42, 43, 44 and the corresponding piezoresistive elements 31, 32, 33, 34 may be made shorter. Accordingly, the temperatures of the respective piezoresistive elements 31, 32, 33, 34 may be sensed more accurately.

Further, the temperature-sensitive elements 41, 42, 43, 44 are provided on the insulating film 24 including the first, second insulating film 22, 23. In other words, the insulating film 24 is provided between the piezoresistive elements 31, 32, 33, 34 and the temperature-sensitive elements 41, 42, 43, 44 provided to overlap with these piezoresistive elements 31, 32, 33, 34. Accordingly, the possibility of short circuit between the piezoresistive elements 31, 32, 33, 34 and the temperature-sensitive elements 41, 42, 43, 44 may be reduced. The configuration of the insulating film 24 is not particularly limited as long as it may insulate the piezoresistive elements 31, 32, 33, 34 and the temperature-sensitive elements 41, 42, 43, 44.

Here, returning to the explanation of the bridge circuit 30, as shown in FIG. 4, the bridge circuit 30 has correction circuit parts 361, 362, 363, 364 (correction part) that correct the resistance values by sensing the current values of the corresponding piezoresistive elements 31, 32, 33, 34 based on the sensing results of the temperature-sensitive elements 41, 42, 43, 44. The correction circuit part 361 is series-connected to the piezoresistive element 31 and located between the piezoresistive element 31 and a midpoint terminal V1. The correction circuit part 362 is series-connected to the piezoresistive element 32 and located between the piezoresistive element 32 and a midpoint terminal V2. The correction circuit part 363 is series-connected to the piezoresistive element 33 and located between the piezoresistive element 33 and the midpoint terminal V2. The correction circuit part 364 is series-connected to the piezoresistive element 34 and located between the piezoresistive element 34 and the midpoint terminal V1. According to the configuration, the output based on the corrected resistance values of the piezoresistive elements 31, 32, 33, 34 is output from the bridge circuit 30, and thereby, output drift due to temperature variations of the respective piezoresistive elements 31, 32, 33, 34 can be corrected in real time and the output with higher accuracy may be obtained.

For comparison, in temperature correction (temperature compensation) of related art, the temperature correction of the piezoresistive elements 31, 32, 33, 34 is not performed within the bridge circuit 30, but the output from the bridge circuit 30 is corrected based on the temperature (for convenience, referred to as “sensed temperature”) sensed by a temperature compensation sensor (so-called “table temperature correction”). Accordingly, if the temperatures of the piezoresistive elements 31, 32, 33, 34 differ from one another or the temperatures of the piezoresistive elements 31, 32, 33, 34 differ from the sensed temperature, precise temperature correction may be impossible. On the other hand, in the bridge circuit 30 of the embodiment, the temperature correction of the piezoresistive elements 31, 32, 33, 34 is performed within the bridge circuit 30, and thereby, precise temperature correction can be performed. Therefore, the pressure sensor 1 having the superior detection accuracy is obtained.

Particularly, in the embodiment, the separation distances between the respective temperature-sensitive elements 41, 42, 43, 44 and the outer edge of the diaphragm 25 are respectively equal. Specifically, the temperature-sensitive elements 41, 42, 43, 44 are respectively provided along the outer edge of the diaphragm 25, and the separation distances between the respective temperature-sensitive elements 41, 42, 43, 44 and the outer edge of the diaphragm 25 are zero. According to the configuration, the stress on the respective temperature-sensitive elements 41, 42, 43, 44 due to flexure of the diaphragm 25 may be made nearly equal. Depending on the configuration of the temperature-sensitive elements 41, 42, 43, 44, the output may be affected by the stress and vary. Accordingly, the separation distances between the respective temperature-sensitive elements 41, 42, 43, 44 and the outer edge of the diaphragm 25 are made respectively equal, and thereby, the influences of the stress on the respective temperature-sensitive elements 41, 42, 43, 44 may be made equal. Therefore, a decrease of pressure sensing accuracy is reduced.

The configuration of the temperature-sensitive elements 41, 42, 43, 44 is not particularly limited as long as they may sense the temperatures. For example, each of the temperature-sensitive elements 41, 42, 43, 44 may be formed using a thermistor element having a temperature-sensing portion of an oxide semiconductor (e.g. barium titanate-series oxide semiconductor) with an electric resistance that varies depending on the temperature. As the thermistor element, either a PTC-type or NTC-type may be used. Each of the temperature-sensitive elements 41, 42, 43, 44 may have a configuration having a temperature-sensing portion of impurity-containing polysilicon (e.g. polysilicon doped (diffusion or implantation) with an impurity such as phosphorus or boron with an electric resistance that varies depending on the temperature. Thereby, the configuration of the temperature-sensitive elements 41, 42, 43, 44 is simpler. The thermistor and the impurity-containing polysilicon have resistance values that largely change depending on the temperature, and the temperatures of the piezoresistive elements 31, 32, 33, 34 may be accurately sensed. Further, the thermistor and the impurity-containing polysilicon are harder to be affected by stress, and, even when they are provided on the diaphragm 25, the temperatures of the piezoresistive elements 31, 33, 34 may be accurately sensed.

Note that, in the embodiment, the temperature sensor part 4 is exposed to the outside of the pressure sensor 1, however, an insulating film may be provided to cover the temperature sensor part 4, for example.

### Base Substrate

As shown in FIG. 1, the base substrate 5 is bonded to the lower surface of the substrate 2 (the surface of the first silicon layer 211) to close the opening of the recessed portion 26 and form the pressure reference chamber S between the diaphragm 25 and itself. The recessed portion 26 is air-tightly sealed by the base substrate 5, and thereby, the pressure reference chamber S is formed. It is preferable that the pressure reference chamber S is in vacuum (e.g. at about 10 Pa or less). Thereby, the pressure sensor 1 may be used as the so-called “absolute pressure sensor” that detects pressure with reference to vacuum. Accordingly, the pressure sensor 1 with higher convenience is obtained. Note that the pressure reference chamber S is not necessarily in the vacuum state as long as it is kept at constant pressure (without consideration of pressure variations due to temperature changes).

As the base substrate 5, e.g. a silicon substrate, glass substrate, ceramic substrate, or the like is used. Note that the base substrate 5 is sufficiently thick compared to the diaphragm 25 so that the portion facing the diaphragm 25 via the pressure reference chamber S may not be deformed by the differential pressure (difference between the pressure of the pressure reference chamber S and the environmental pressure).

### Second Embodiment

Next, a pressure sensor according to the second embodiment of the invention will be explained.

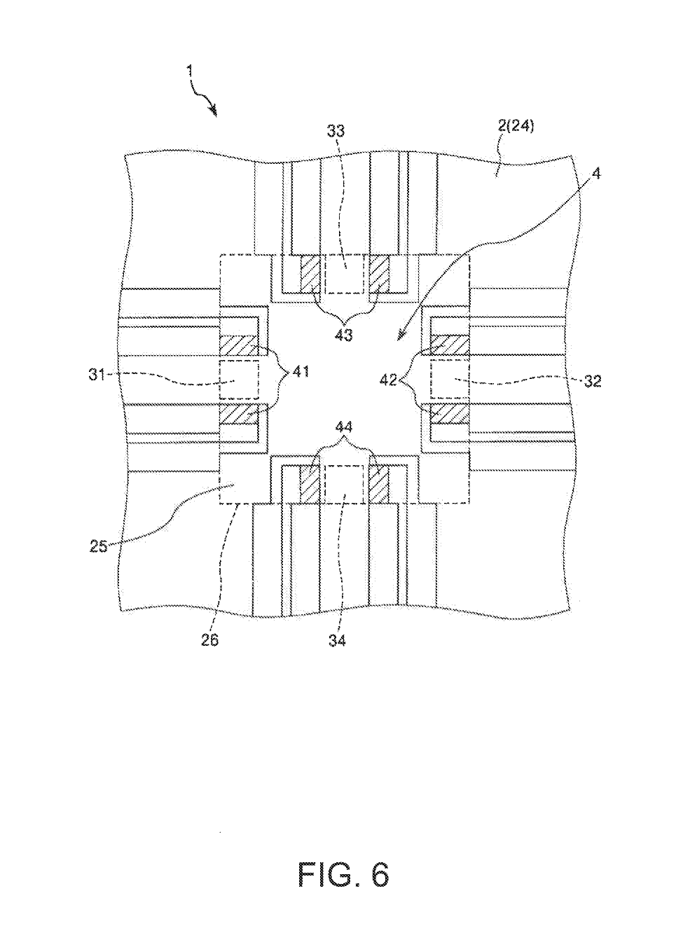

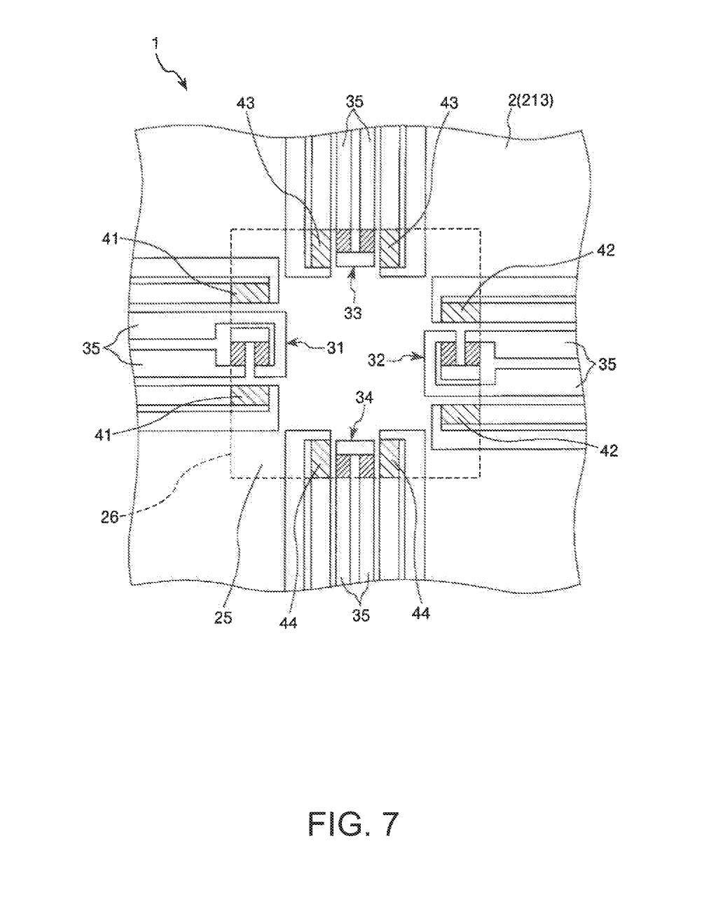

FIG. 6 is a plan view of the pressure sensor according to the second embodiment of the invention. FIG. 7 is a plan view showing a modified example of the pressure sensor shown in FIG. 6.

As below, the pressure sensor of the second embodiment will be explained with a focus on differences from the above described embodiment, and the explanation of the same items will be omitted.

The pressure sensor of the second embodiment is the same as the above described first embodiment except that the configuration of the temperature sensor is different. The same configurations as those of the above described embodiment have the same signs.

As shown in FIG. 6, in the plan view of the diaphragm 25, the temperature-sensitive elements 41 are provided on the sides of the piezoresistive element 31, the temperature-sensitive elements 42 are provided on the sides of the piezoresistive element 32, the temperature-sensitive elements 43 are provided on the sides of the piezoresistive element 33, and the temperature-sensitive elements 44 are provided on the sides of the piezoresistive element 34. More specifically, the temperature-sensitive elements 41 are provided in the direction along the outer edge of the diaphragm 25 side by side with the piezoresistive element 31, the temperature-sensitive elements 42 are provided in the direction along the outer edge of the diaphragm 25 side by side with the piezoresistive element 32 the temperature-sensitive elements 43 are provided in the direction along the outer edge of the diaphragm 25 side by side with the piezoresistive element 33, and the temperature-sensitive elements 44 are provided in the direction along the outer edge of the diaphragm 25 side by side with the piezoresistive element 34. As described above, the temperature-sensitive elements 41, 42, 43, 44 are provided side by side with the corresponding piezoresistive elements 31, 32, 33, 34, and thereby, the separation distances between the temperature-sensitive elements 41, 42, 43, 44 and the corresponding piezoresistive elements 31, 32, 33, 34 may be made shorter. Accordingly, the temperatures of the respective piezoresistive elements 31, 32, 33, 34 may be sensed more accurately.

Further, the temperature-sensitive elements 41 are provided in a pair with the corresponding piezoresistive element 31 in between, the temperature-sensitive elements 42 are provided in a pair with the corresponding piezoresistive element 32 in between, the temperature-sensitive elements 43 are provided in a pair with the corresponding piezoresistive element 33 in between, and the temperature-sensitive elements 44 are provided in a pair with the corresponding piezoresistive element 34 in between. For example, an average value of the temperatures detected by the pair of temperature-sensitive elements 41 is used as the temperature of the piezoresistive element 31, and thereby, the temperature of the piezoresistive element 31 may be sensed more precisely. The same applies to the temperature-sensitive elements 42, 43, 44.

According to the second embodiment, the same effects as those of the above described first embodiment may be exerted. Note that, in the embodiment, the temperature-sensitive elements 41, 42, 43, 44 are provided on the insulating film 24, however, the arrangement is not limited to that. For example, as shown in FIG. 7, the elements may be provided on the second silicon layer 213. In this case, the wires connected to the temperature-sensitive elements 41, 42, 43, 44 may be formed in the second silicon layer 213 like the wires 35.

### Third Embodiment

Next, a pressure sensor according to the third embodiment of the invention will be explained.

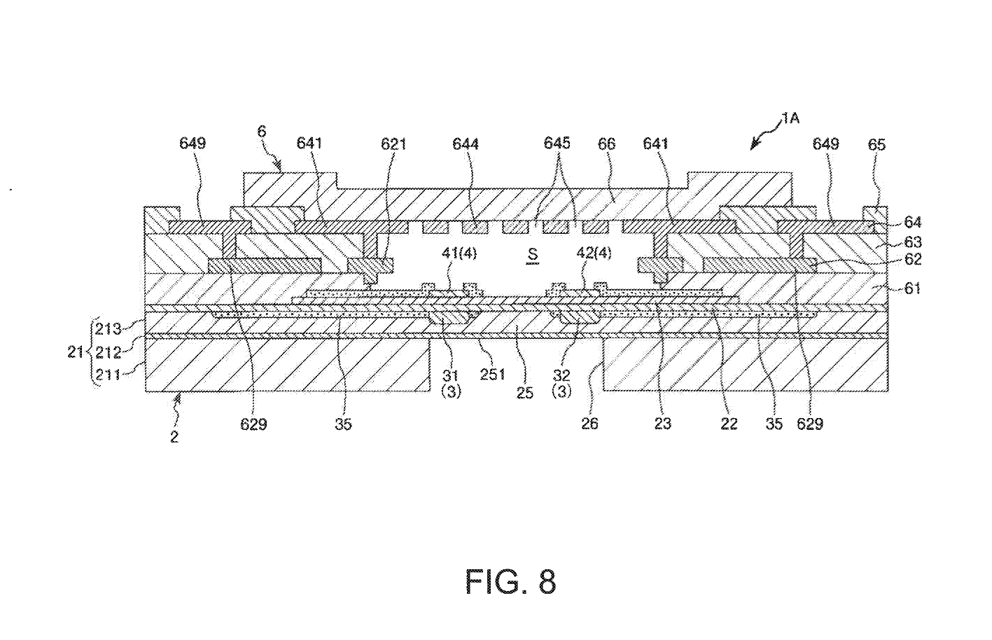

FIG. 8 is a sectional view of the pressure sensor according to the third embodiment of the invention.

As below, the pressure sensor of the third embodiment will be explained with a focus on differences from the above described embodiments, and the explanation of the same items will be omitted.

A pressure sensor 1A shown in FIG. 8 has the substrate 2, the pressure sensor part 3, the temperature sensor part 4, a surrounding structure 6, and the pressure reference chamber S (cavity part). The configurations of the substrate 2, the pressure sensor part 3, the temperature sensor part 4, and the pressure reference chamber S are respectively the same as those of the above described first embodiment, and the surrounding structure 6 will be mainly explained as below.

### Surrounding Structure

The surrounding structure 6 forms the pressure reference chamber S between the substrate 2 and itself. The surrounding structure 6 has an interlayer insulating film 61 provided on the substrate 2, a wiring layer 62 provided on the interlayer insulating film 61, an interlayer insulating film 63 provided on the wiring layer 62 and the interlayer insulating film 61, a wiring layer 64 provided on the interlayer insulating film 63, a surface protective film 65 provided on the wiring layer 64 and the interlayer insulating film 63, and a sealing layer 66 provided on the wiring layer 64 and the surface protective film 65.

The wiring layer 62 has a frame-shaped wiring portion 621 provided to surround the pressure reference chamber S, and a wiring portion 629 electrically connected to the pressure sensor part 3 and the temperature sensor part 4. Similarly, the wiring layer 64 has a frame-shaped wiring portion 641 provided to surround the pressure reference chamber S, and a wiring portion 649 electrically connected to the pressure sensor part 3 and the temperature sensor part 4. Further, the pressure sensor part 3 and the temperature sensor part 4 are extracted to the upper surface of the surrounding structure 6 by the wiring portions 629, 649.

The wiring layer 64 has a covering layer 644 located on the ceiling of the pressure reference chamber S. Further, a plurality of through holes 645 for communication between inside and outside of the pressure reference chamber S are provided in the covering layer 644. The covering layer 644 is integrally formed with the wiring portion 641 and provided to be opposed to the diaphragm 25 with the pressure reference chamber S in between. The plurality of through holes 645 are holes for release etching when a sacrifice layer filling the pressure reference chamber S in the middle of the manufacture is removed. Furthermore, the sealing layer 66 is provided on the covering layer 644 and the through holes 645 are sealed by the sealing layer 66.

The surface protective film 65 has a function of protecting the surrounding structure 6 from moisture, dirt, scratches, etc. The surface protective film 65 is provided on the interlayer insulating film 63 and the wiring layer 64 not to close the through holes 645 of the covering layer 644.

Of the surrounding structure 6, as the interlayer insulating films 61, 63, e.g. insulating films such as silicon oxide films (SiO2) may be used. As the wiring layers 62, 64, e.g. metal films such as aluminum films may be used. As the sealing layer 66, e.g. a metal film of Al, Cu, W, Ti, TiN, or the like, a silicon oxide film, or the like may be used. As the surface protective film 65, e.g. a silicon oxide film, silicon nitride film, polyimide film, epoxy resin film, or the like may be used.

According to the third embodiment, the same effects as those of the above described first embodiment may be exerted.

### Fourth Embodiment

Next, an altimeter according to the fourth embodiment of the invention will be explained.

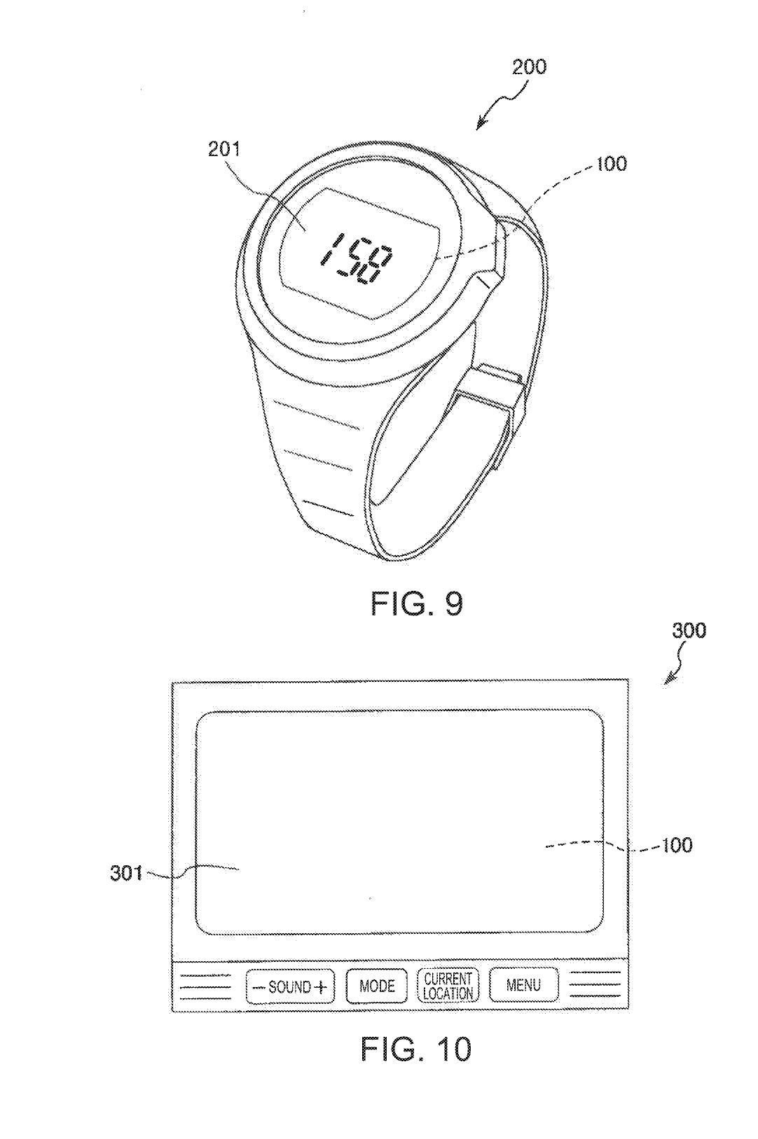

FIG. 9 is a perspective view showing an example of an altimeter according to the invention.

An altimeter 200 shown in FIG. 9 may be worn on a wrist like a wristwatch. The altimeter 200 has the pressure sensor 1 mounted inside, and may display the altitude of the current location above the sea level, the atmospheric pressure of the current location, etc. on a display part 201. In the display part 201, additionally, various kinds of information including the current time, the heart rate of the user, the weather, etc. may be displayed. The altimeter 200 has the pressure sensor 1 having superior detection accuracy and may exert higher reliability.

With a waterproof property, the altimeter 200 can be used as a hydro-bathometer for diving or free diving, for example.

### Fifth Embodiment

Next, an electronic apparatus according to the fifth embodiment of the invention will be explained.

FIG. 10 is a front view showing an example of an electronic apparatus according to the invention.

The electronic apparatus shown in FIG. 10 is a navigation system 300 including the pressure sensor 1. The navigation system 300 includes map information (not shown), position information acquisition means from GPS (Global Positioning System), self-contained navigation means using a gyro sensor and an acceleration sensor, and vehicle velocity data, the pressure sensor 1, and a display part 301 that displays predetermined position information or route information.

According to the navigation system 300, in addition to the acquired position information, altitude information may be acquired by the pressure sensor 1. Accordingly, an altitude change by entry from a general road to an elevated road (or vice versa) is detected, and thereby, whether traveling on the general road or traveling on the elevated road may be determined and navigation information in a real traveling state may be provided to the user. The navigation system 300 has the pressure sensor 1 with the superior detection accuracy and may exert higher reliability.

Note that the electronic apparatus including the pressure sensor according to the invention is not limited to the above described navigation system, but may be applied to e.g. a personal computer, cell phone, smartphone, tablet terminal, wearable terminal such as HMD (head mount display), watch (including smartwatch), medical device (e.g. electronic thermometer, sphygmomanometer, blood glucose meter, electrocardiographic measurement system, ultrasonic diagnostic system, or electronic endoscope), various measuring instruments meters and gauges (e.g. meters for vehicles, airplanes, and ships), flight simulator, or the like.

### Sixth Embodiment

Next, a vehicle according to the sixth embodiment of the invention will be explained.

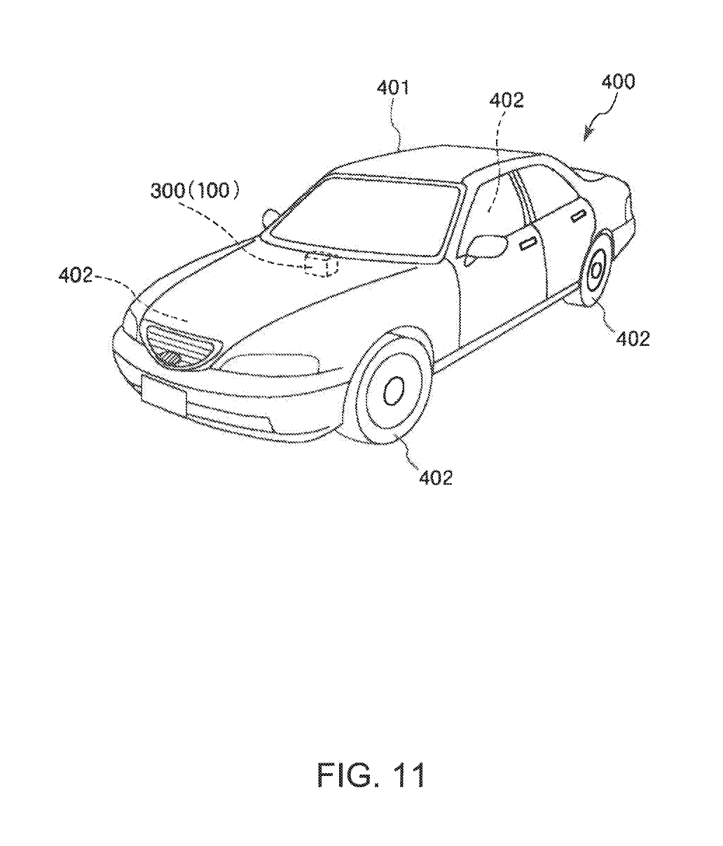

FIG. 11 is a perspective view showing an example of a vehicle according to the invention.

The vehicle shown in FIG. 11 is an automobile 400 including the pressure sensor 1. The automobile 400 has a vehicle body 401 and four wheels 402, and is adapted to turn the wheels 402 by a power source (engine) (not shown) provided in the vehicle body 401. The automobile 400 has the pressure sensor 1 with the superior detection accuracy, and may exert the higher reliability.

As above, the pressure sensor, altimeter, electronic apparatus, and vehicle are explained based on the respective illustrated embodiments, however, the invention is not limited to those. The configurations of the respective parts may be replaced by arbitrary configurations having the same functions. Further, other arbitrary configurations and steps may be added thereto. Furthermore, the respective embodiments may be appropriately combined.

The entire disclosure of Japanese Patent Application No. 2016-063262, filed Mar. 28, 2016 is expressly incorporated by reference herein.

What is claimed is:

1. A pressure sensor comprising:
a diaphragm that flexurally deforms when pressurized;
a plurality of piezoresistive elements provided in the diaphragm; and
a plurality of temperature-sensitive elements provided in the diaphragm in correspondence with the plurality of piezoresistive elements,
wherein a separation distance between the piezoresistive element and the temperature-sensitive element corresponding to each other is shorter than a separation distance between the piezoresistive element and the temperature-sensitive element not corresponding to each other.

2. The pressure sensor according to claim 1, wherein each of the temperature-sensitive elements is provided to at least partially overlap with the corresponding piezoresistive element in a plan view the diaphragm.

3. The pressure sensor according to claim 2, wherein an insulating film is provided between the piezoresistive element and the temperature-sensitive element provided to overlap with the piezoresistive element.

4. The pressure sensor according to claim 1, wherein each of the temperature-sensitive elements is provided side by side with the corresponding piezoresistive element.

5. The pressure sensor according to claim 4, wherein a pair of the temperature-sensitive elements are provided with the corresponding piezoresistive element in between.

6. The pressure sensor according to claim 1, wherein separation distances between the temperature-sensitive elements and an outer edge of the diaphragm are equal.

7. The pressure sensor according to claim 1, wherein each of the temperature-sensitive elements has a temperature-sensitive portion including an oxide semiconductor.

8. The pressure sensor according to claim 1, wherein each of the temperature-sensitive elements has a temperature-sensitive portion including impurity-containing polysilicon.

9. The pressure sensor according to claim 1, wherein a bridge circuit is formed by the plurality of piezoresistive elements.

10. The pressure sensor according to claim 9, wherein the bridge circuit has a correction part that corrects resistance values of the corresponding piezoresistive elements based on sensing results of the temperature-sensitive elements.

11. An altimeter comprising the pressure sensor according to claim 1.

12. An altimeter comprising the pressure sensor according to claim 2.

13. An altimeter comprising the pressure sensor according to claim 3.

14. An altimeter comprising the pressure sensor according to claim 4.

15. An electronic apparatus comprising the pressure sensor according to claim 1.

16. An electronic apparatus comprising the pressure sensor according to claim 2.

17. An electronic apparatus comprising the pressure sensor according to claim 3.

18. A vehicle comprising the pressure sensor according to claim 1.

19. A vehicle comprising the pressure sensor according to claim 2.

20. A vehicle comprising the pressure sensor according to claim 3.
